(19) United States
(12) Patent Application Publication
(10) Pub. No.: US 2026/0310546 A1
(43) Pub. Date: Oct. 8, 2026

(54) ENHANCED ERROR DETECTION MODE FOR MEMORY DEVICES

(71) Applicant: Micron Technology, Inc., Boise, ID (US)

(72) Inventor: Scott E. SCHAEFER, Boise, ID (US)

(21) Appl. No.: 19/561,356

(22) Filed: Mar. 9, 2026

Related U.S. Application Data
(60) Provisional application No. 63/785,365, filed on Apr. 8, 2025.

(51) Int. Cl. G06F 11/10

(52) U.S. Cl. CPC G06F 11/1016; G06F 11/1068

(57) ABSTRACT

In some implementations, a memory apparatus may obtain, from a host system, a message comprising data to be stored to one or more memory arrays of a memory apparatus. The memory apparatus may perform, based at least in part on operating in an error detection mode, an error detection operation associated with the error detection mode on the data and an error correction operation associated with an error correction mode on the data. The memory apparatus may provide, as part of the error detection mode, a first one or more values associated with the error detection operation and a second one or more values associated with the error correction operation.

### CROSS-REFERENCE TO RELATED APPLICATION

This Patent Application claims priority to U.S. Provisional Patent Application No. 63/785,365, filed on Apr. 8, 2025, entitled “ENHANCED ERROR DETECTION MODE FOR MEMORY DEVICES,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to enhanced error detection mode for memory devices.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source.

### BRIEF DESCRIPTION OF THE DRAWINGS

FIG. 1 is a diagram illustrating an example system capable of an enhanced error detection mode for memory devices.

FIG. 2 is a diagrammatic view of an example memory device.

FIG. 3 shows an example of a data packet that supports an enhanced error detection mode for memory devices.

FIG. 4 is a diagram of an example of an enhanced error detection mode for memory devices.

FIG. 5 is a flowchart of an example method associated with an enhanced error detection mode for memory devices.

FIG. 6 is a flowchart of an example method associated with an enhanced error detection mode for memory devices.

### DETAILED DESCRIPTION

Some memory systems may support multiple link error control modes, such as an error detection mode and an error control mode to enhance data integrity of information communicated between a host system and a memory system. Such modes may support either detecting or correcting errors that may occur in data as the data is transferred between the host system and the memory system. For example, in an error correction mode, the memory system may use parity information included with data to be written to correct one or more errors, such as a single-bit error (SBE), in the data. Additionally, in an error detection mode, the memory apparatus may detect whether the data includes one or more errors (e.g., SBEs and/or multi-bit errors (MBEs)), but may not correct errors. Some systems may assume that a memory system is operating either in an error detection mode or an error correction mode, but not both. However, such an approach may limit the ability of the host system to determine information about link errors that occur during such modes. For example, if the error detection mode detects an error, and the error is an SBE, the host system may treat the data as corrupted, despite the SBE being correctable.

Some implementations described herein enable an enhanced error detection mode for a memory system. For example, to write data as part of the enhanced error detection mode, a host system may generate a data packet and parity information associated with the data packet.

Based on, in response to, or otherwise associated with obtaining the data packet, the memory system may perform an error detection operation on data of the data packet using the parity information. If the error detection operation detects that the data contains one or more errors, then the memory system may store a first value (e.g., a logic “1”) to a first mode register, such as a fault mode register. Alternatively, if the error detection operation does not detect that the data contains an error, then the memory system may store a second value (e.g., a logic “0”) to the first mode register.

As part of the error detection mode, the memory system may also perform an error correction operation, such as an error correction operation configured to correct a single bit (e.g., a single error correction (SEC) operation) on the payload and/or the metadata. For example, if the error detection operation detects that one or more errors exist in the payload and/or the metadata, then the memory apparatus may execute the error correction operation to attempt to correct at least one error in the payload and/or the metadata. If the error correction operation corrects at least one error in the payload and/or the metadata, then the memory system may store a first value (e.g., a logic “1”) to a second mode register (e.g., a second fault mode register). Alternatively, if the error correction operation did not correct an error in the data, then the memory system may store a second value (e.g., a logic “0”) to the second mode register.

The host system may read the first and second mode registers to determine information associated with the error detection operation. For example, if the error detection operation detects at least one error and the error correction operation corrects an error (e.g., indicated by the first and second fault mode registers), then the host system may determine, with a high degree of probability, that the memory system corrected all errors in the data. Said another way, because the probability of a multi-bit error may be much lower than the probability of a single-bit error, the host system may determine a high likelihood that the data is “good” (e.g., error free) data. The host system may then determine whether to treat the data as error free (e.g., based on an importance and/or sensitivity of the data, among other considerations). Alternatively, if the error detection operation detects at least one error and the error correction does not correct an error in the data, the host system may determine that the data contains a multi-bit error, and may thus treat the data as “bad” data.

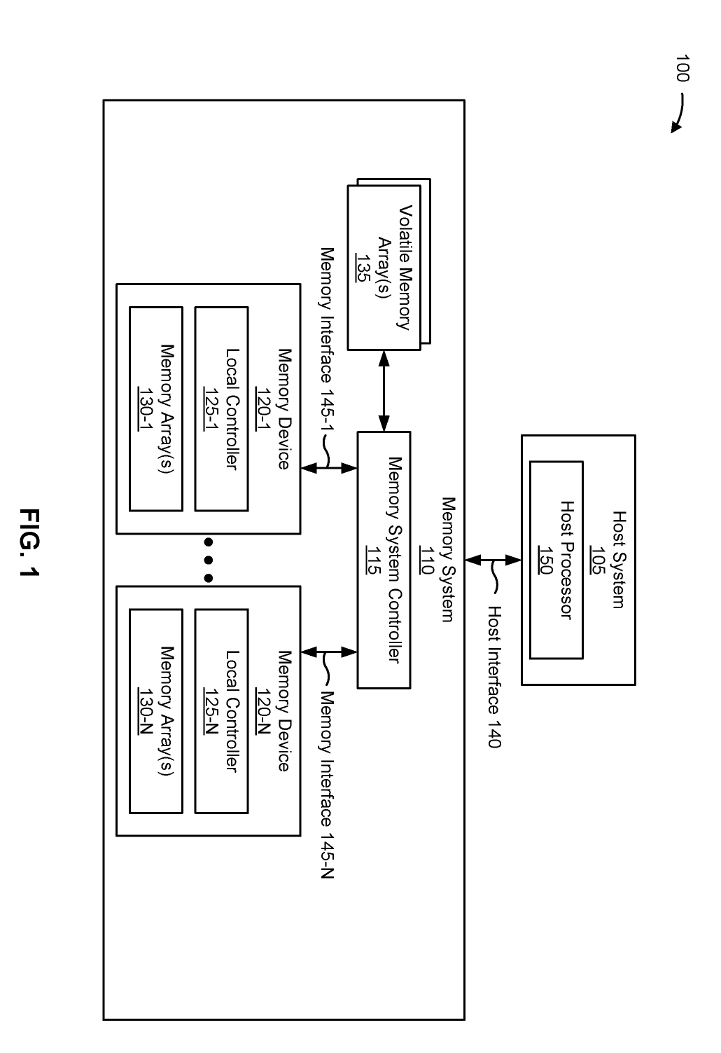

FIG. 1 is a diagram illustrating an example system 100 capable of an enhanced error detection mode for memory devices. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, and/or a DIMM interface.

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to: obtain, from a host system, a message comprising data to be stored to one or more memory arrays of the memory device; perform, based at least in part on operating in an error detection mode, an error detection operation associated with the error detection mode on the data and an error correction operation associated with an error correction mode on the data; and provide, to the host system and as part of the error detection mode, a first one or more values associated with the error detection operation and a second one or more values associated with the error correction operation.

In some implementations, one or more systems, devices, apparatuses, components, and/or controllers of FIG. 1 may be configured to: communicate, via a host interface to a memory apparatus, a message comprising data to be stored to one or more memory arrays of the memory apparatus; perform, based at least in part on operating in an error detection mode, an error detection operation associated with the error detection mode on the data and an error correction operation associated with an error correction mode, on the data; and communicate, via the host interface to a host system and as part of the error detection mode, a first one or more values associated with the error detection operation and a second one or more values associated with the error correction operation.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

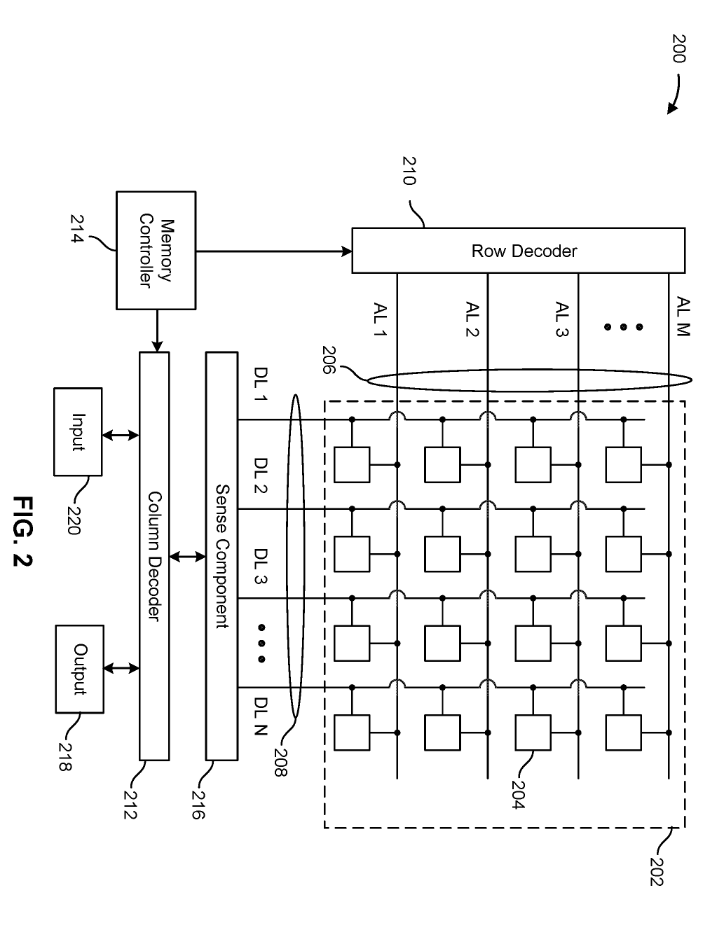

FIG. 2 is a diagrammatic view of an example memory device 200. The memory device 200 may include a memory array 202 that includes multiple memory cells 204. A memory cell 204 is programmable or configurable into a data state of multiple data states (e.g., two or more data states). For example, a memory cell 204 may be set to a particular data state at a particular time, and the memory cell 204 may be set to another data state at another time. A data state may correspond to a value stored by the memory cell 204. The value may be a binary value, such as a binary 0 or a binary 1, or may be a fractional value, such as 0.5, 1.5, or the like. A memory cell 204 may include a capacitor to store a charge representative of the data state. For example, a charged and an uncharged capacitor may represent a first data state and a second data state, respectively. As another example, a first level of charge (e.g., fully charged) may represent a first data state, a second level of charge (e.g., fully discharged) may represent a second data state, a third level of charge (e.g., partially charged) may represent a third data state, and so on.

Operations such as reading and writing (i.e., cycling) may be performed on memory cells 204 by activating or selecting the appropriate access line 206 (shown as access lines AL 1 through AL M) and digit line 208 (shown as digit lines DL 1 through DL N). An access line 206 may also be referred to as a “row line” or a “word line,” and a digit line 208 may also be referred to a “column line” or a “bit line.” Activating or selecting an access line 206 or a digit line 208 may include applying a voltage to the respective line. An access line 206 and/or a digit line 208 may comprise, consist of, or consist essentially of a conductive material, such as a metal (e.g., copper, aluminum, gold, titanium, or tungsten) and/or a metal alloy, among other examples. In FIG. 2, each row of memory cells 204 is connected to a single access line 206, and each column of memory cells 204 is connected to a single digit line 208. By activating one access line 206 and one digit line 208 (e.g., applying a voltage to the access line 206 and digit line 208), a single memory cell 204 may be accessed at (e.g., is accessible via) the intersection of the access line 206 and the digit line 208. The intersection of the access line 206 and the digit line 208 may be called an “address” of a memory cell 204.

In some implementations, the logic storing device of a memory cell 204, such as a capacitor, may be electrically isolated from a corresponding digit line 208 by a selection component, such as a transistor. The access line 206 may be connected to and may control the selection component. For example, the selection component may be a transistor, and the access line 206 may be connected to the gate of the transistor. Activating the access line 206 results in an electrical connection or closed circuit between the capacitor of a memory cell 204 and a corresponding digit line 208. The digit line 208 may then be accessed (e.g., is accessible) to either read from or write to the memory cell 204.

A row decoder 210 and a column decoder 212 may control access to memory cells 204. For example, the row decoder 210 may receive a row address from a memory controller 214 and may activate the appropriate access line 206 based on the received row address. Similarly, the column decoder 212 may receive a column address from the memory controller 214 and may activate the appropriate digit line 208 based on the column address.

Upon accessing a memory cell 204, the memory cell 204 may be read (e.g., sensed) by a sense component 216 to determine the stored data state of the memory cell 204. For example, after accessing the memory cell 204, the capacitor of the memory cell 204 may discharge onto its corresponding digit line 208. Discharging the capacitor may be based on biasing, or applying a voltage, to the capacitor. The discharging may induce a change in the voltage of the digit line 208, which the sense component 216 may compare to a reference voltage (not shown) to determine the stored data state of the memory cell 204. For example, if the digit line 208 has a higher voltage than the reference voltage, then the sense component 216 may determine that the stored data state of the memory cell 204 corresponds to a first value, such as a binary 1. Conversely, if the digit line 208 has a lower voltage than the reference voltage, then the sense component 216 may determine that the stored data state of the memory cell 204 corresponds to a second value, such as a binary 0. The detected data state of the memory cell 204 may then be output (e.g., via the column decoder 212) to an output component 218 (e.g., a data buffer). A memory cell 204 may be written (e.g., set) by activating the appropriate access line 206 and digit line 208. The column decoder 212 may receive data, such as input from input component 220, to be written to one or more memory cells 204. A memory cell 204 may be written by applying a voltage across the capacitor of the memory cell 204.

The memory controller 214 may control the operation (e.g., read, write, re-write, refresh, and/or recovery) of the memory cells 204 via the row decoder 210, the column decoder 212, and/or the sense component 216. The memory controller 214 may generate row address signals and column address signals to activate the desired access line 206 and digit line 208. The memory controller 214 may also generate and control various voltages used during the operation of the memory array 202.

The memory device 200 may support an enhanced error detection mode. For example, to write data as part of the enhanced error detection mode, a host system may generate a data packet and parity information associated with the data packet. Based on, in response to, or otherwise associated with obtaining the data packet, the memory device 200 and/or one or more components coupled with the memory device 200 may perform an error detection operation on data of the data packet using the parity information. If the error detection operation detects that the data contains one or more errors, then the memory system may store a first value (e.g., a logic “1”) to a first mode register, such as a fault mode register. Alternatively, if the error detection operation does not detect that data contains an error, then the memory device 200 and/or one or more components coupled with the memory device 200 may store a second value (e.g., a logic “0”) to the first mode register.

As part of the error detection mode, the memory device 200 and/or one or more components coupled with the memory device 200 may also perform an error correction operation, such as an error correction operation configured to correct a single bit (e.g., an SEC operation) on the payload and/or the metadata. For example, if the error detection operation detects that one or more errors exist in the payload and/or the metadata, then the memory apparatus may execute the error correction operation to attempt to correct at least one error in the payload and/or the metadata. If the error correction operation corrects at least one error in the payload and/or the metadata, then the memory device 200 and/or one or more components coupled with the memory device 200 may store a first value (e.g., a logic “1”) to a second mode register (e.g., a second fault mode register). Alternatively, if the error correction operation did not correct an error in the data, then the memory device 200 and/or one or more components coupled with the memory device 200 may store a second value (e.g., a logic “0”) to the second mode register.

The host system may read the first and second mode registers to determine information associated with the error detection operation. For example, if the error detection operation detects at least one error and the error correction operation corrects an error (e.g., indicated by the first and second fault mode registers), then the host system may determine, with a high degree of probability, that the memory device 200 and/or one or more components coupled with the memory device 200 corrected all errors in the data. Said another way, because the probability of a multi-bit error may be much lower than the probability of a single-bit error, the host system may determine a high likelihood that the data is “good” (e.g., error free) data. The host system may then determine whether to treat the data as error free (e.g., based on an importance and/or sensitivity of the data, among other considerations). Alternatively, if the error detection operation detects at least one error and the error correction does not correct an error in the data, the host system may determine that the data contains a multi-bit error, and may thus treat the data as “bad” data.

As indicated above, FIG. 2 is provided as an example. Other examples may differ from what is described with respect to FIG. 2.

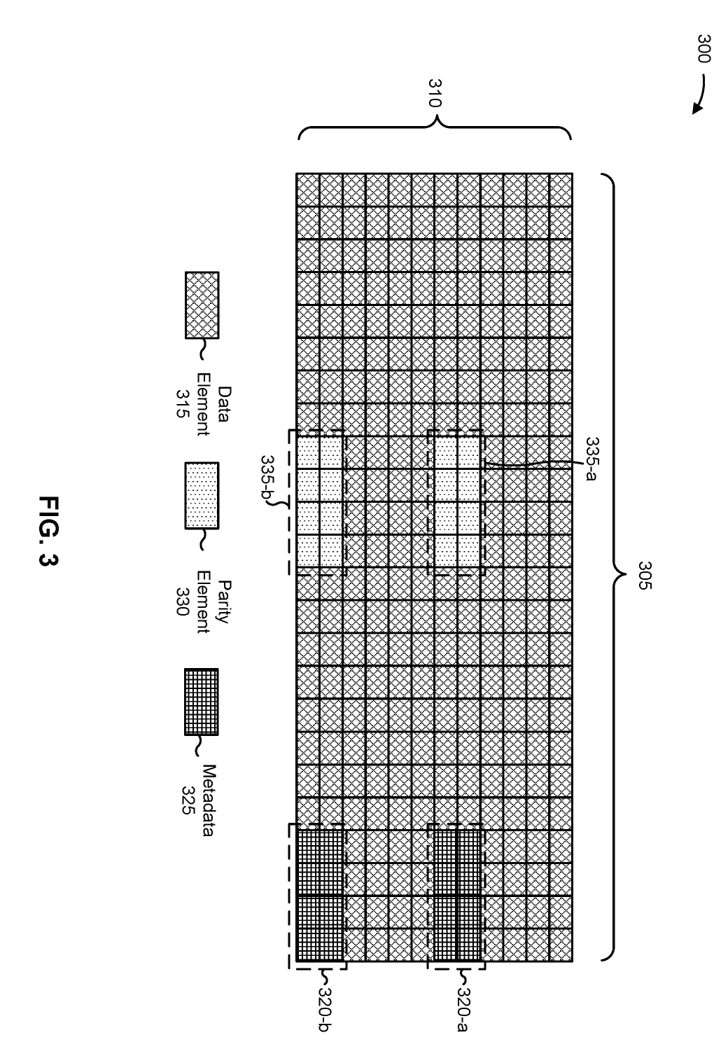

FIG. 3 shows an example of a data packet 300 that supports an enhanced error detection mode for memory devices. The data packet 300 illustrates a format of signaling communicated between a host system (e.g., the host system 105) and a memory apparatus (e.g., the memory system 110, one or more memory devices 120) specified by a communication protocol, such as a format used for a burst operation (e.g., a write burst operation and/or a read burst operation).

The data packet 300 may include one or more elements arranged according to one or more time intervals 305, which may be referred to as “beats,” and one or more pins 310 of a bus (e.g., a host interface 140) between the host system and the memory apparatus. Said another way, each pin 310 of the bus may communicate a single element between the host system and the memory system during each time interval 305. An element corresponding to a given time interval 305 and a given pin 310 may represent a voltage level of the given pin 310 during the given time interval 305. For example, an element may be a single bit, such as a high state (e.g., a logic “1”) or a low state (e.g., a logic “0”) at an edge (e.g., a rising edge, a falling edge) of a clock signal used as part of binary signaling. Additionally, or alternatively, an element may correspond to a voltage level of another signaling scheme, such as non-return-to-zero (NRZ) signaling, three-level pulse-amplitude modulation (PAM-3) signaling, and/or PAM-4 signaling, among other examples.

The one or more elements may include one or more data elements 315. The one or more data elements 315 of the data packet may represent the payload of the data packet 300, such as user data communicated between the host system and the memory system.

In some examples, the communication protocol may provision the one or more locations 320 within the data packet 300 to include metadata (e.g., one or more metadata elements 325) associated with the payload of the data packet 300. For example, the communication protocol may specify that metadata may be included at the location 320-a and/or the location 320-b, as illustrated in FIG. 3. Said another way, the communication protocol may provision the locations 320 for metadata. In some cases, the host system may place the one or more metadata elements 325 in the locations 320.

The host system and/or the memory apparatus may support one or more link error control modes, such as a link error detection mode and/or a link error correction mode, in which the host system may place parity information, such as one or more parity elements 330 in one or more locations 335 (e.g., one or more subsets of the time intervals 305 and/or the pins 310, one or more portions of the data packet 300), such as a location 335-a and/or a location 335-b. By way of example, to operate in an error detection mode, the host system may provide, and the memory apparatus may obtain, a command to initiate the error detection mode. Based on, in response to, or otherwise associated with obtaining the command, the memory apparatus may store a value indicative of the error detection mode, such as by setting a flag of (e.g., writing a logical “1” to) one or more mode registers.

Although the example of a data packet 300 illustrated in FIG. 3 shows the metadata elements 325 in the locations 320-a and/or 320-b and the parity elements 330 in the locations 335-a and/or 335-a, some implementations described herein may include placing the metadata elements 325 in the locations 335-a and/or 335-b and placing the parity elements 330 in the locations 320-a and/or 320-b. More generally, metadata elements 325 and/or parity elements 330 may be placed in all or a portion of the locations 320-a, 320-b, 335-a, and/or 335-b. In some examples, a location configuration may indicate particular locations for metadata elements 325 and/or parity elements 330. For example, the host system may generate the location configuration, and may provide an indication of the location configuration to the memory apparatus.

To write data as part of the error detection mode, the host system may generate a first data packet 300 (e.g., as part of a write burst operation associated with the error detection mode). The host system may generate the parity elements 330 by performing an error control operation on a payload of the first data packet 300 (e.g., on one or more data elements 315). In some examples, the host system may also perform the error control operation on metadata in one or more locations 320 (e.g., one or more metadata elements 325 placed in a location 320-a and/or a location 320-b). Said another way, the parity information may be an error control code of the error control operation. The host system may place the parity elements 330 in the locations 335. The host system may provide, and the memory apparatus may obtain, the first data packet 300.

Based on, in response to, or otherwise associated with obtaining the first data packet 300, the memory apparatus may perform an error detection operation on the payload using the parity information. If the error detection operation detects that the payload and/or the metadata contains one or more errors, then the memory apparatus may store a first value (e.g., a logic “1”) to a first mode register, such as a fault mode register. Alternatively, if the error detection operation does not detect that payload and/or the metadata contains an error, then the memory apparatus may store a second value (e.g., a logic “0”) to the first mode register. In some examples, the memory apparatus may not store the parity information after performing the error detection operation (e.g., the memory apparatus may discard the parity information).

As part of the error detection mode, the memory apparatus may also perform an error correction operation, such as an error correction operation configured to correct a single bit (e.g., an SEC operation) on the payload and/or the metadata. For example, if the error detection operation detects that one or more errors exist in the payload and/or the metadata, then the memory apparatus may execute the error correction operation to attempt to correct at least one error in the payload and/or the metadata. If the error correction operation corrects at least one error in the payload and/or the metadata, then the memory apparatus may store a first value (e.g., a logic “1”) to a second mode register (e.g., a second fault mode register). Alternatively, if the error correction operation did not correct an error in the data, then the memory apparatus may store a second value (e.g., a logic “0”) to the second mode register.

A fault mode register may be a register within the memory apparatus configured to log one or more error conditions, such as critical errors, write-link errors, or other conditions detected during operation. A status of one or more fault mode registers of the memory apparatus may include one or more values (e.g., one or more bits, one or more flags), indicating the one or more error conditions. For example, each value may indicate whether the memory apparatus has detected a respective error condition. Based on, in response to, or otherwise associated with a read command from the host system, the memory apparatus may identify the status of the one or more fault mode registers, and may provide the status to the host system. In some examples, the memory system may provide the status of each fault mode register of the one or more fault mode registers. Alternatively, the memory apparatus may provide the status of a subset of the one or more fault mode registers (e.g., a subset indicated by the read command).

In some examples, the memory apparatus may use a same set of circuitry to perform the error detection operation and the error correction operation at least partially in parallel. For example, the memory apparatus may include an error control engine configured to perform both the error detection operation and the error correction operation.

By way of example, the error control engine may calculate a syndrome used to determine whether one or more errors exist in the payload and/or the metadata. A non-zero syndrome may indicate that one or more errors exist in the payload and/or the metadata. Thus, if the error control engine calculates a non-zero syndrome, then the memory apparatus may determine that the error detection operation detected at least one error in the payload and/or the metadata, and accordingly the memory apparatus may store a value indicating that the error detection operation detected at least one error to the first fault mode register. The error control engine may then analyze the syndrome to attempt to correct all or a portion of the one or more errors. For example, if the syndrome corresponds to a known single-bit error pattern, then the error control engine may identify a corresponding bit of the payload and/or the metadata to correct (e.g., by flipping the corresponding bit). In such a case, the memory apparatus may determine that the error correction operation corrected an error in the payload and/or the metadata, and may store a first value (e.g., a logic “1”) to the second fault mode register. Alternatively, if the syndrome corresponds to a multi-bit error pattern, then the memory apparatus may determine that the error detected by the error detection operation is a multi-bit error, and may store a second value (e.g., a logic “0”) to the second fault mode register.

By performing the error correction operation at least partially in parallel with the error detection operation, the host system and/or the memory apparatus may enhance the reliability of the data written as part of the error detection mode. Further, the memory apparatus may allow the host to determine with increased accuracy whether a detected error was a single-bit error or a multi-bit error. For example, if the error detection operation detects at least one error and the error correction operation corrects an error (e.g., indicated by the first and second fault mode registers), then the host system may determine, with a high degree of probability, that the memory apparatus corrected all errors in the data. Said another way, because the probability of a multi-bit error may be much lower than the probability of a single-bit error, the host system may determine a high likelihood that the data is “good” (e.g., error free) data. The host system may then determine whether to treat the data as error free (e.g., based on an importance and/or sensitivity of the data, among other considerations). Alternatively, if the error detection operation detects at least one error and the error correction does not correct an error in the data, the host system may determine that the data contains a multi-bit error, and may thus treat the data as “bad” data.

As indicated above, FIG. 3 is provided as an example. Other examples may differ from what is described with regard to FIG. 3.

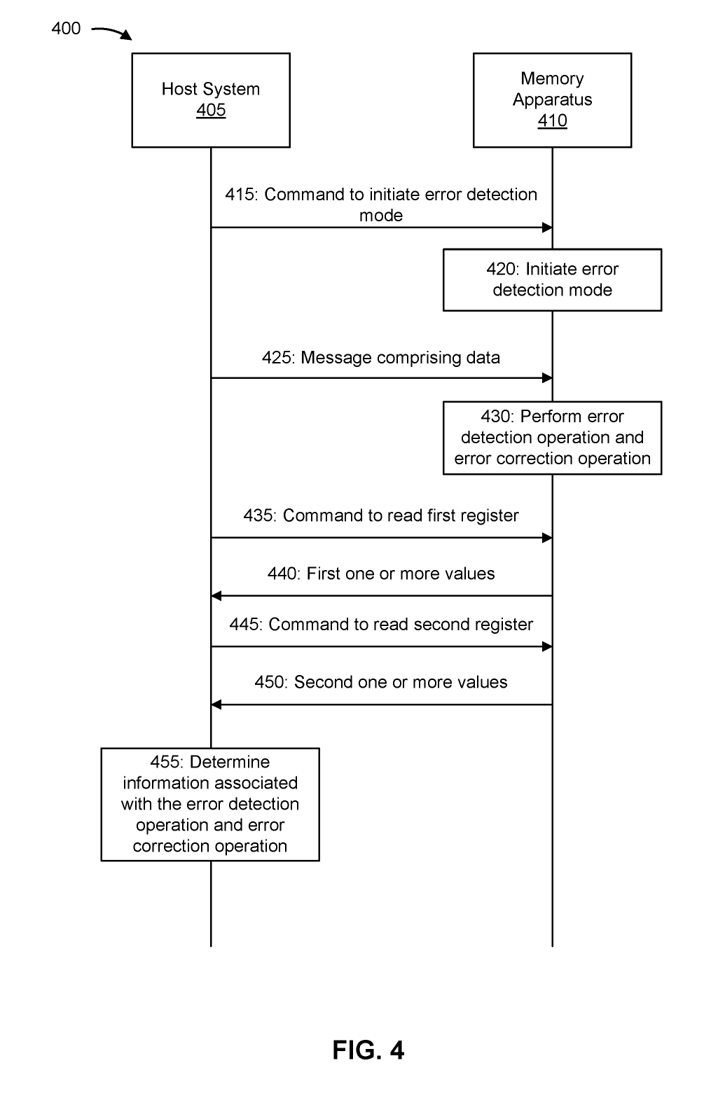

FIG. 4 is a diagram of an example 400 of an enhanced error detection mode for memory devices. The operations described in connection with FIG. 4 may be performed by a system, such as the system 100 and/or one or more components thereof, such as the host system 105, the host interface 140, the memory system 110, the memory system controller 115, one or more memory devices 120, and/or one or more local controllers 125.

As shown in FIG. 4, the example 400 may include a host system 405 and a memory apparatus 410. The host system 405 may be the host system 105. The memory apparatus 410 may be or may include the memory system 110, one or more memory devices 120, and/or one or more controllers (e.g., the memory system controller 115 and/or one or more local controllers 125).

The example 400 illustrates a process to implement enhanced link error detection for data stored to the memory apparatus 410.

For example, as shown by reference number 415, the host system 405 may provide, and the memory apparatus 410 may obtain, a command indicating that the memory apparatus 410 is to operate in the error detection mode. In some examples, as shown by reference number 420, the memory apparatus 410 may initiate the error detection mode. To initiate the error detection mode, the memory apparatus may store a value indicative of the error detection mode, such as by setting a flag of (e.g., writing a logical “1” to) one or more mode registers. In such examples, the command may be a mode register write command.

As shown by reference number 425, the host system 405 may provide, and the memory apparatus 410 may obtain, a message that includes data to be stored to one or more memory arrays of the memory apparatus 410. For example, the host system 405 may generate a payload and/or metadata of a first data packet to be written to the memory apparatus 410. In some examples, the host system 405 may generate parity information (e.g., link parity information) by performing one or more error control operations on the payload and/or system metadata. In such examples, the message may further include the parity information.

As shown by reference number 430, the memory apparatus 410 may perform, as part of operation in the error detection mode, an error detection operation and an error correction operation on the data, such as by using an error control engine as described herein. If the error detection operation detects that the payload and/or the metadata contains one or more errors, then the memory apparatus 410 may store a first value (e.g., a logic “1”) to a first mode register. Alternatively, if the error detection operation does not detect that payload and/or the metadata contains an error, then the memory apparatus may store a second value (e.g., a logic “0”) to the first mode register.

Additionally, as part of the error detection mode, the memory apparatus 410 may perform an error correction operation on the payload and/or the metadata. For example, if the error detection operation detects that one or more errors exist in the payload and/or the metadata, then the memory apparatus 410 may execute the error correction operation to attempt to correct at least one error in the payload and/or the metadata. If the error correction operation corrects at least one error in the payload and/or the metadata, then the memory apparatus may store a first value (e.g., a logic “1”) to a second mode register. Alternatively, if the error correction operation did not correct an error in the data, then the memory apparatus 410 may store a second value (e.g., a logic “0”) to the second mode register. In some examples, the memory apparatus 410 may store one or more values to a single register to indicate information associated with the error detection operation and the error correction operation. For example, the memory apparatus 410 may store a multi-bit value to a mode register indicate the result of both the error detection operation and the error correction operation.

In some examples, the memory apparatus 410 may perform the error detection operation and the error correction operation at least partially in parallel. For example, using the error control engine described herein, the memory apparatus 410 may identify, in a first time window, that one or more errors exist in the data (e.g., by determining that a syndrome associated with the error detection operation is non-zero). Additionally, using the error control engine, the memory apparatus 410 may correct an error of the one or more errors in a second time window that at least partially overlaps in time with the first time window.

The host system 405 may retrieve information associated with the error detection operation and the error correction operation from the memory apparatus 410. For example, as shown by reference number 435, the host system 405 may provide, and the memory apparatus 410 may obtain, a first command to read the first register. As shown by reference number 440, based on, in response to, or otherwise associated with obtaining the first command, the memory apparatus 410 may provide, and the host system 405 may obtain, the value stored to the first register.

Additionally, as shown by reference number 445, the host system 405 may provide, and the memory apparatus 410 may obtain, a second command to read the second register. As shown by reference number 450, based on, in response to, or otherwise associated with obtaining the second command, the memory apparatus 410 may provide, and the host system 405 may obtain, the value stored to the second register.

The memory apparatus 410 may indicate the result of the error detection operation and the error correction operation in other ways. For example, the host system 405 may provide a single command to obtain both the value of the first mode register and the value of the second mode register. Additionally, or alternatively, the memory apparatus 410 may provide the values of the first mode register and the second mode register to the host system 405 as part of a fault monitoring operation.

As shown by reference number 455, the host system 405 may use the first one or more values and the second one or more values to determine information associated with the error detection operation. For example, if the error detection operation detects at least one error and the error correction operation corrects an error (e.g., indicated by the first and second fault mode registers), then the host system 405 may determine, with a high degree of probability, that the memory apparatus 410 corrected all errors in the data. Said another way, because the probability of a multi-bit error may be much lower than the probability of a single-bit error, the host system 405 may determine a high likelihood that the data is “good” (e.g., error free) data. The host system 405 may then determine whether to treat the data as error free (e.g., based on an importance and/or sensitivity of the data, among other considerations). Alternatively, if the error detection operation detects at least one error and the error correction does not correct an error in the data, the host system 405 may determine that the data contains a multi-bit error, and may thus treat the data as “bad” data.

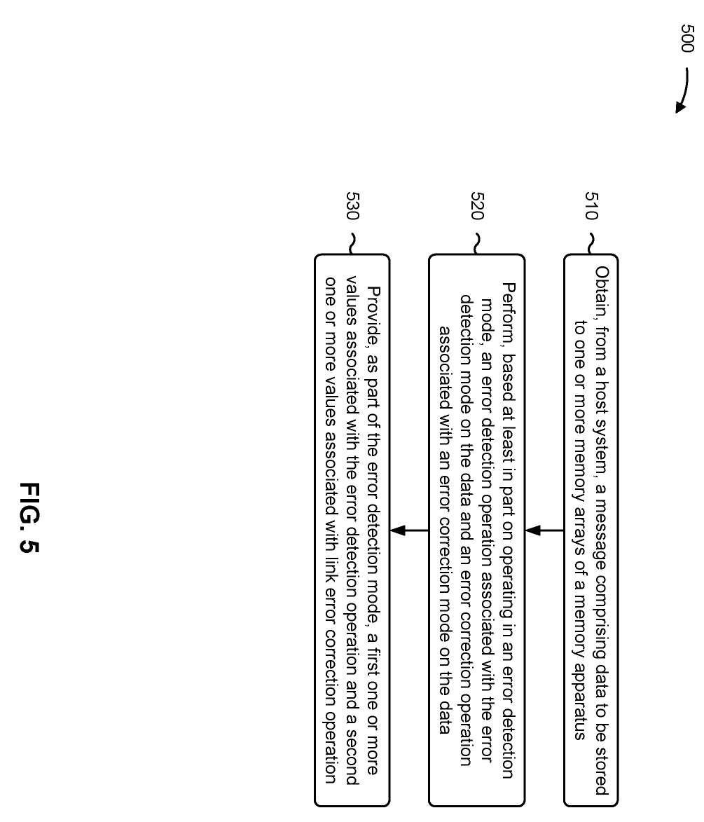

FIG. 5 is a flowchart of an example method 500 associated with an enhanced error detection mode for memory devices. In some implementations, a memory apparatus (e.g., the memory apparatus 410 and/or the memory system 110) may perform or may be configured to perform the method 500. In some implementations, another device or a group of devices separate from or including the memory apparatus (e.g., the system host system 105, the host interface 140, and/or the host system 405) may perform or may be configured to perform the method 500. Additionally, or alternatively, one or more components of the memory apparatus (e.g., a memory system controller 115, one or more volatile memory arrays 135, one or more memory devices 120, and/or a memory controller 214) may perform or may be configured to perform the method 500. Thus, means for performing the method 500 may include the memory apparatus and/or one or more components of the memory apparatus. Additionally, or alternatively, a non-transitory computer-readable medium may store one or more instructions that, when executed by the memory apparatus, cause the memory apparatus to perform the method 500.

As shown in FIG. 5, the method 500 may include obtaining, from a host system, a message comprising data to be stored to one or more memory arrays of a memory apparatus (block 510). As further shown in FIG. 5, the method 500 may include performing, based at least in part on operating in an error detection mode, an error detection operation associated with the error detection mode on the data and an error correction operation associated with an error correction mode on the data (block 520). As further shown in FIG. 5, the method 500 may include providing, as part of the error detection mode, a first one or more values associated with the error detection operation and a second one or more values associated with the error correction operation (block 530).

The method 500 may include additional aspects, such as any single aspect or any combination of aspects described below and/or described in connection with one or more other methods or operations described elsewhere herein.

In a first aspect, the method 500 includes storing the first one or more values to a first register, and storing the second one or more values to a second register.

In a second aspect, alone or in combination with the first aspect, providing the first one or more values and the second one or more values comprises receiving, from the host system, a first command to read the first register, transmitting, in response to obtaining the first command, the one or more first values to the host system, receiving, from the host system, a second command to read the second register, and transmitting, in response to obtaining the second command, the second one or more values to the host system.

In a third aspect, alone or in combination with one or more of the first and second aspects, the first one or more values indicate that the error detection operation detected a first one or more errors in the data, and the second one or more values indicate that the error correction operation corrected an error of the one or more errors in the data.

In a fourth aspect, alone or in combination with one or more of the first through third aspects, the first register and the second register are respective fault mode registers.

In a fifth aspect, alone or in combination with one or more of the first through fourth aspects, the method 500 includes obtaining, from the host system, a command indicating that the memory apparatus is to initiate the error detection mode, and initiating the error detection mode based at least in part on the command.

In a sixth aspect, alone or in combination with one or more of the first through fifth aspects, the method 500 includes storing, in response to obtaining the command, a value indicating the error detection mode to one or more mode registers of the memory apparatus.

In a seventh aspect, alone or in combination with one or more of the first through sixth aspects, performing the error detection operation and the error correction operation comprises identifying, as part of the error detection operation and in a first time window, that one or more errors exist in the data, and correcting, as part of the error correction operation and in a second time window, an error of the one or more errors in the data, wherein the first time window at least partially overlaps with the second time window.

In an eighth aspect, alone or in combination with one or more of the first through seventh aspects, the message further comprises parity information associated with the data.

In a ninth aspect, alone or in combination with one or more of the first through eighth aspects, the error detection operation is a link error detection operation, and the error correction operation is a link error correction operation.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

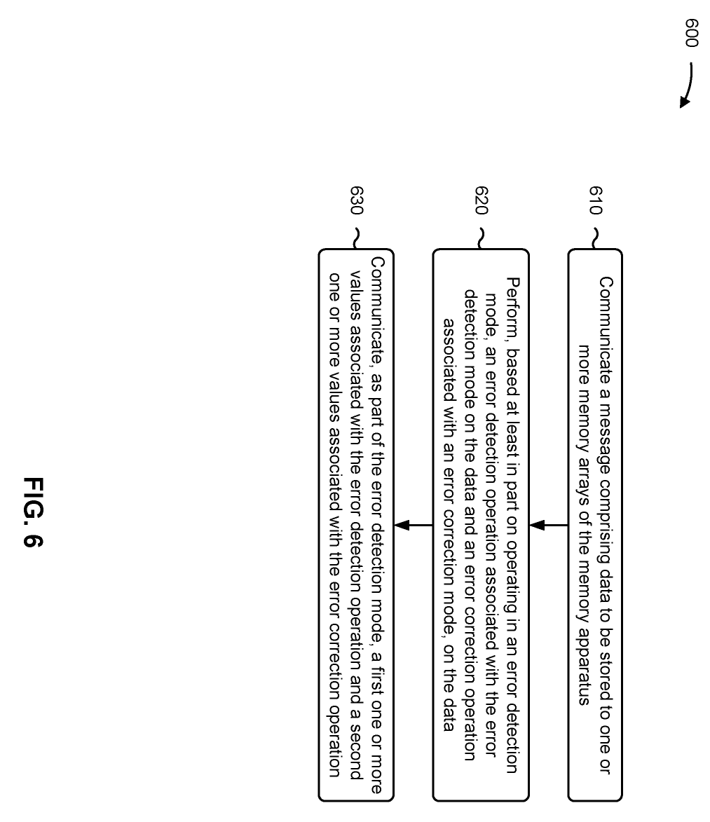

FIG. 6 is a flowchart of an example method 600 associated with an enhanced error detection mode for memory devices. In some implementations, a system (e.g., the system 100) may perform or may be configured to perform the method 600. Additionally, or alternatively, one or more components of the system (e.g., the host system 105, the memory system 110, the host system 405, and/or the memory apparatus 410) may perform or may be configured to perform the method 600. Thus, means for performing the method 600 may include the system and/or one or more components of the system. Additionally, or alternatively, a non-transitory computer-readable medium may store one or more instructions that, when executed by the system, cause the system to perform the method 600.

As shown in FIG. 6, the method 600 may include communicating a message comprising data to be stored to one or more memory arrays of the memory apparatus (block 610). As further shown in FIG. 6, the method 600 may include performing, based at least in part on operating in an error detection mode, an error detection operation associated with the error detection mode on the data and an error correction operation associated with an error correction mode, on the data (block 620). As further shown in FIG. 6, the method 600 may include communicating, as part of the error detection mode, a first one or more values associated with the error detection operation and a second one or more values associated with the error correction operation (block 630).

The method 600 may include additional aspects, such as any single aspect or any combination of aspects described below and/or described in connection with one or more other methods or operations described elsewhere herein.

In a first aspect, the method 600 includes determining, by the host system based on the first one or more values and the second one or more values, that the memory apparatus corrected one or more errors in the data.

In a second aspect, alone or in combination with the first aspect, the method 600 includes generating, by the host system, parity information for the data, wherein the message further comprises the parity information.

In a third aspect, alone or in combination with one or more of the first and second aspects, the method 600 includes storing the first one or more values to a first register, and storing the second one or more values to a second register.

In a fourth aspect, alone or in combination with one or more of the first through third aspects, communicating the first one or more values and the second one or more values comprises communicating, via the host interface to the memory apparatus, a first command to read the first register, communicating, via the host interface to the host system and in response to obtaining the first command, the one or more first values, communicating, via the host interface to the memory apparatus, a second command to read the second register, and communicating, via the host interface to the host system and in response to obtaining the second command, the second one or more values.

In a fifth aspect, alone or in combination with one or more of the first through fourth aspects, the first one or more values indicate that the error detection operation detected a first one or more errors in the data, and the second one or more values indicate that the error correction operation corrected an error of the one or more errors in the data.

In a sixth aspect, alone or in combination with one or more of the first through fifth aspects, the first register and the second register are respective fault mode registers.

In a seventh aspect, alone or in combination with one or more of the first through sixth aspects, the method 600 includes communicating, via the host interface to the memory apparatus, a command indicating that the memory apparatus is to initiate the error detection mode, and initiating the error detection mode based at least in part on the command.

In an eighth aspect, alone or in combination with one or more of the first through seventh aspects, the method 600 includes storing, in response to obtaining the command, a value indicating the error detection mode to one or more mode registers of the memory apparatus.

In a ninth aspect, alone or in combination with one or more of the first through eighth aspects, performing the error detection operation and the error correction operation comprises identifying, in a first time window, that one or more errors exist in the data, and correcting, in a second time window, an error of the one or more errors in the data, wherein the first time window at least partially overlaps with the second time window.

In a tenth aspect, alone or in combination with one or more of the first through ninth aspects, the error detection operation is a link error detection operation, and the error correction operation is a link error correction operation.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory device includes one or more components configured to: obtain, from a host system, a message comprising data to be stored to one or more memory arrays of the memory device; perform, based at least in part on operating in an error detection mode, an error detection operation associated with the error detection mode on the data and an error correction operation associated with an error correction mode on the data; and provide, to the host system and as part of the error detection mode, a first one or more values associated with the error detection operation and a second one or more values associated with the error correction operation.

In some implementations, a system includes a host system; a memory apparatus; a host interface between the host system and the memory apparatus; and one or more controllers configured to: communicate, via the host interface to the memory apparatus, a message comprising data to be stored to one or more memory arrays of the memory apparatus; perform, by the memory apparatus and based at least in part on operating in an error detection mode, an error detection operation associated with the error detection mode on the data and an error correction operation associated with an error correction mode, on the data; and communicate, via the host interface to the host system and as part of the error detection mode, a first one or more values associated with the error detection operation and a second one or more values associated with the error correction operation.

In some implementations, a method includes obtaining, from a host system, a message comprising data to be stored to one or more memory arrays of a memory apparatus; performing, by a memory apparatus and based at least in part on operating in an error detection mode, an error detection operation associated with the error detection mode on the data and an error correction operation associated with an error correction mode on the data; and providing, by the memory apparatus to the host system and as part of the error detection mode, a first one or more values associated with the error detection operation and a second one or more values associated with the error correction operation.

In some implementations, a method includes communicating, by a host system via a host interface to a memory apparatus, a message comprising data to be stored to one or more memory arrays of the memory apparatus; performing, by the memory apparatus and based at least in part on operating in an error detection mode, an error detection operation associated with the error detection mode on the data and an error correction operation associated with an error correction mode, on the data; and communicating, by the memory apparatus via the host interface to the host system and as part of the error detection mode, a first one or more values associated with the error detection operation and a second one or more values associated with the error correction operation.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory device, comprising:
one or more components configured to:
obtain, from a host system, a message comprising data to be stored to one or more memory arrays of the memory device;
perform, based at least in part on operating in an error detection mode, an error detection operation associated with the error detection mode on the data and an error correction operation associated with an error correction mode on the data; and
provide, to the host system and as part of the error detection mode, a first one or more values associated with the error detection operation and a second one or more values associated with the error correction operation.

2. The memory device of claim 1, wherein the one or more components are further configured to:
store the first one or more values to a first register; and
store the second one or more values to a second register.

3. The memory device of claim 2, wherein, to provide the first one or more values and the second one or more values, the one or more components are further configured to:
receive, from the host system, a first command to read the first register;
transmit, in response to obtaining the first command, the one or more first values to the host system;
receive, from the host system, a second command to read the second register; and
transmit, in response to obtaining the second command, the second one or more values to the host system.

4. The memory device of claim 2, wherein:
the first one or more values indicate that the error detection operation detected a first one or more errors in the data; and
the second one or more values indicate that the error correction operation corrected an error of the one or more errors in the data.

5. The memory device of claim 2, wherein the first register and the second register are respective fault mode registers.

6. The memory device of claim 1, wherein the one or more components are further configured to:
obtain, from the host system, a command indicating that the memory device is to initiate the error detection mode; and
initiate the error detection mode based at least in part on the command.

7. The memory device of claim 6, wherein the one or more components are further configured to:
store, in response to obtaining the command, a value indicating the error detection mode to one or more mode registers of the memory device.

8. The memory device of claim 1, wherein to perform the error detection operation and the error correction operation, the one or more components are configured to:
identify, as part of the error detection operation and in a first time window, that one or more errors exist in the data; and
correct, as part of the error correction operation and in a second time window, an error of the one or more errors in the data, wherein the first time window at least partially overlaps with the second time window.

9. The memory device of claim 1, wherein the message further comprises parity information associated with the data.

10. The memory device of claim 1, wherein:
the error detection operation is a link error detection operation; and
the error correction operation is a link error correction operation.

11. A system, comprising:
a host system;
a memory apparatus;
a host interface between the host system and the memory apparatus; and
one or more controllers configured to:
communicate, via the host interface to the memory apparatus, a message comprising data to be stored to one or more memory arrays of the memory apparatus;
perform, by the memory apparatus and based at least in part on operating in an error detection mode, an error detection operation associated with the error detection mode on the data and an error correction operation associated with an error correction mode, on the data; and
communicate, via the host interface to the host system and as part of the error detection mode, a first one or more values associated with the error detection operation and a second one or more values associated with the error correction operation.

12. The system of claim 11, wherein the one or more controllers are further configured to:
determine, by the host system and based on the first one or more values and the second one or more values, that the memory apparatus corrected one or more errors in the data.

13. The system of claim 11, wherein the one or more controllers are further configured to:
generate, by the host system, parity information for the data, wherein the message further comprises the parity information.

14. The system of claim 11, wherein the one or more controllers are further configured to:
store, by the memory apparatus, the first one or more values to a first register; and
store, by the memory apparatus, the second one or more values to a second register.

15. The system of claim 14, wherein, to communicate the first one or more values and the second one or more values, the one or more controllers are further configured to:
communicate, via the host interface to the memory apparatus, a first command to read the first register;
communicate, via the host interface to the host system and in response to obtaining the first command, the one or more first values;
communicate, via the host interface to the memory apparatus, a second command to read the second register; and
communicate, via the host interface to the host system and in response to obtaining the second command, the second one or more values.

16. The system of claim 14, wherein:
the first one or more values indicate that the error detection operation detected a first one or more errors in the data; and
the second one or more values indicate that the error correction operation corrected an error of the one or more errors in the data.

17. The system of claim 14, wherein the first register and the second register are respective fault mode registers.

18. The system of claim 11, wherein the one or more controllers are further configured to:
communicate, via the host interface to the memory apparatus, a command indicating that the memory apparatus is to initiate the error detection mode; and
initiate, by the memory apparatus, the error detection mode based at least in part on the command.

19. The system of claim 18, wherein the one or more controllers are further configured to:
store, in response to obtaining the command, a value indicating the error detection mode to one or more mode registers of the memory apparatus.

20. The system of claim 11, wherein to perform the error detection operation and the error correction operation, the one or more controllers are configured to:
identify, by the memory apparatus as part of the error detection operation and in a first time window, that one or more errors exist in the data; and
correct, by the memory apparatus as part of the error correction operation and in a second time window, an error of the one or more errors in the data, wherein the first time window at least partially overlaps with the second time window.

21. The system of claim 11, wherein:
the error detection operation is a link error detection operation; and
the error correction operation is a link error correction operation.

22. A method, comprising:
obtaining, from a host system, a message comprising data to be stored to one or more memory arrays of a memory apparatus;
performing, by a memory apparatus and based at least in part on operating in an error detection mode, an error detection operation associated with the error detection mode on the data and an error correction operation associated with an error correction mode on the data; and
providing, by the memory apparatus to the host system and as part of the error detection mode, a first one or more values associated with the error detection operation and a second one or more values associated with the error correction operation.

23. The method of claim 22, further comprising:
storing the first one or more values to a first register; and
storing the second one or more values to a second register.

24. The method of claim 23, wherein providing the first one or more values and the second one or more values comprises:
receiving, from the host system, a first command to read the first register;
transmitting, in response to obtaining the first command, the one or more first values to the host system;
receiving, from the host system, a second command to read the second register; and
transmitting, in response to obtaining the second command, the second one or more values to the host system.

25. The method of claim 23, wherein:
the first one or more values indicate that the error detection operation detected a first one or more errors in the data; and
the second one or more values indicate that the error correction operation corrected an error of the one or more errors in the data.
